(19) United States
(12) Patent Application Publication
(10) Pub. No.: US 2025/0239060 A1
(43) Pub. Date: Jul. 24, 2025

(54) TARGETING AND MANIPULATING OBJECTS OF INTEREST

(71) Applicant: Carbon Autonomous Robotic Systems Inc., Seattle, WA (US)

(72) Inventors: Simon Cochrane, Seattle, WA (US); Brian Phillip Stark, Bothell, WA (US); Jarod Richard White, Seattle, WA (US)

(21) Appl. No.: 19/034,354

(22) Filed: Jan. 22, 2025

Related U.S. Application Data
(60) Provisional application No. 63/623,902, filed on Jan. 23, 2024.

(51) Int. Cl. G06V 10/776; A01M 21/04; G06T 7/70; G06V 10/98; G06V 20/10; G06V 20/56

(52) U.S. Cl. CPC G06V 10/776; G06T 7/70; G06V 10/993; G06V 20/188; G06V 20/56; A01M 21/04; G06T 2207/20081; G06T 2207/30188; G06T 2207/30252

(57) ABSTRACT

Systems and methods for reducing latency of targeting and manipulating of an object of interest is provided. The method includes receiving an image of the object of interest, generating a predicted location of the object of interest based on the received image, applying an offset learned by a machine learning model, the offset representing a difference between a prediction system and a targeting system, causing an adjustment to an implement, and targeting the object of interest with the adjusted implement after the offset is applied.

### CROSS-REFERENCE TO RELATED APPLICATION(S)

The present application claims the benefit of priority to U.S. Provisional Application No. 63/623,902 filed Jan. 23, 2024, which is incorporated by reference herein in its entirety.

### TECHNICAL FIELD

The present technology relates to systems and methods for reducing latency of targeting and manipulation of an object of interest.

### BACKGROUND

Agricultural output is valued at trillions of dollars annually worldwide. Agriculture is an essential component of food production and includes cultivation of both livestock and plants. Rising population and decreased crop yield due to changing climate threaten global food security. Methods for increasing agricultural production by improving crop yield and boosting labor efficiency may help mitigate food shortages.

As technology in agriculture advances, tasks that had previously been performed by humans are increasingly becoming automated. While tasks performed in highly controlled environments, such as factory assembly lines, can be automated by directing a machine to perform the task the same way each time, tasks performed in unpredictable environments, such as agricultural environments, depend on dynamic feedback and adaptation to perform the task. Autonomous systems often struggle to identify and locate objects in unpredictable environments.

Due to agriculture being unpredictable at times, improved methods of object tracking and manipulation of targets would advance automation technology and increase the ability of autonomous systems to react and adapt to unpredictable environments.

### SUMMARY

The subject technology is illustrated, for example, according to various aspects described below, including with reference to FIGS. 1-5B. Various examples of aspects of the subject technology are described as numbered clauses (1, 2, 3, etc.) for convenience. These are provided as examples and do not limit the subject technology.

1. A method of targeting an object of interest using a computing system comprising a prediction system and a targeting system, the method comprising:
receiving, from a camera, an image of the object of interest;
generating, by the prediction system, a predicted location of the object of interest based on the image;
generating an offset representing a difference between the prediction system and the targeting system;
applying the offset to the predicted location to generate a speculative position prediction of the object of interest
causing an adjustment to an implement based on the speculative position prediction; and
targeting and manipulating the object of interest with the adjusted implement based on the speculative position prediction after the offset is applied.

2. The method of clause 1, further comprising:
generating, by the targeting system, a high accuracy prediction of the object of interest; and
comparing, by the targeting system, the high accuracy prediction to the speculative position prediction to assess an accuracy of the prediction system.

3. The method of clause 2, further comprising updating an accuracy assessment of the prediction system based on the high accuracy prediction and the speculative position prediction.

4. The method of clause 2 or 3, further comprising:
based on the comparing, determining, by the targeting system, that an error between the high accuracy prediction and the speculative position prediction is outside an acceptable margin of error; and
based on the determining:
   causing a further adjustment to the implement based on the high accuracy prediction, and
      targeting and manipulating the object of interest after the implement is adjusted.

5. The method of any one of clauses 2-4, further comprising:
based on the comparing, determining, by the targeting system, that an error between the high accuracy prediction and the speculative position prediction is within an acceptable margin of error; and
based on the determining, continuing to manipulate the object of interest with the adjusted implement.

6. The method of any one of clauses 1-5, further comprising:
generating the offset between the prediction system and the targeting system based on a statistical model of historical errors between predicted positions generated by the prediction system and high accuracy predictions generated by the targeting system, wherein the statistical model is based on a window of the historical errors between the predicted positions and the high accuracy predictions.

7. The method of clause 6, wherein the statistical model comprises a rolling average of the historical errors.

8. The method of any one of clauses 1-7, wherein the offset is learned via a machine learning model.

9. The method of any one of clauses 1-8, wherein the object of interest is a plant.

10. The method of any one of clauses 1-9, wherein the implement comprises a light emitter.

11. A system comprising:
a prediction system; and
a targeting system, wherein the prediction system and the targeting system operate in conjunction to perform operations comprising:
receiving, from a camera, an image of an object of interest;
generating, by the prediction system, a predicted location of the object of interest based on the image;
generating an offset representing a difference between the prediction system and the targeting system;
applying the offset to the predicted location to generate a speculative position prediction of the object of interest;
causing an adjustment to an implement based on the speculative position prediction; and
targeting and manipulating the object of interest with the adjusted implement based on the speculative position prediction after the offset is applied.

12. The system of clause 11, wherein the operations further comprise:
generating, by the targeting system, a high accuracy prediction of the object of interest; and
comparing, by the targeting system, the high accuracy prediction to the speculative position prediction to assess an accuracy of the prediction system.

13. The system of clause 12, wherein the operations further comprise updating an accuracy assessment of the prediction system based on the high accuracy prediction and the speculative position prediction.

14. The system of clause 12 or 13, wherein the operations further comprise:
based on the comparing, determining, by the targeting system, that an error between the high accuracy prediction and the speculative position prediction is outside an acceptable margin of error; and
based on the determining:
   causing a further adjustment to the implement based on the high accuracy prediction, and
   targeting and manipulating the object of interest after the implement is adjusted.

15. The system of any one of clauses 12-14, wherein the operations further comprise:
based on the comparing, determining, by the targeting system, that an error between the high accuracy prediction and the speculative position prediction is within an acceptable margin of error; and
based on the determining, continuing to manipulate the object of interest with the adjusted implement.

16. The system of any one of clauses 1-15, wherein the operations further comprise: generating the offset between the prediction system and the targeting system based on a statistical model of historical errors between predicted positions generated by the prediction system and high accuracy predictions generated by the targeting system, wherein the statistical model is based on a window of historical errors between the predicted positions and the high accuracy predictions.

17. The system of clause 16, wherein the statistical model comprises a rolling average of the historical errors.

18. The system of any one of clauses 1-17, wherein the offset is learned via a machine learning model.

19. The system of any one of clauses 11-18, wherein the object of interest is a plant.

20 The system of any one of clauses 11-19, wherein the implement comprises a light emitter.

21. A non-transitory computer readable medium having instructions stored thereon that, when executed by a processor, causes a computing system to perform operations comprising:
receiving, from a camera, an image of an object of interest;
generating, by the prediction system, a predicted location of the object of interest based on the image;
generating an offset representing a difference between the prediction system and the targeting system;
applying the offset to the predicted location to generate a speculative position prediction of the object of interest;
causing an adjustment to an implement based on the speculative position prediction; and
targeting and manipulating the object of interest with the adjusted implement based on the speculative position prediction after the offset is applied.

22. The non-transitory computer readable medium of clause 21, wherein the operations further comprise:
generating, by the targeting system, a high accuracy prediction of the object of interest; and
comparing, by the targeting system, the high accuracy prediction to the speculative position prediction to assess an accuracy of the prediction system.

23. The non-transitory computer readable medium of clause 22, wherein the operations further comprise updating an accuracy assessment of the prediction system based on the high accuracy prediction and the speculative position prediction.

24. The non-transitory computer readable medium of clause 22 or 23, wherein the operations further comprise:
based on the comparing, determining, by the targeting system, that an error between the high accuracy prediction and the speculative position prediction is outside an acceptable margin of error; and
based on the determining:
   causing a further adjustment to the implement based on the high accuracy prediction, and
   targeting and manipulating the object of interest after the implement is adjusted.

25. The non-transitory computer readable medium of any one of clauses 22-24, wherein the operations further comprise:
based on the comparing, determining, by the targeting system, that an error between the high accuracy prediction and the speculative position is within an acceptable margin of error; and
based on the determining, continuing to manipulate the object of interest with the adjusted implement.

26. The non-transitory computer readable medium of any one of clauses 21-25, wherein the operations further comprise:
generating the offset between the prediction system and the targeting system based on a rolling average of historical errors between predicted positions and high accuracy predictions.

27 The non-transitory computer readable medium of clause 26, wherein the statistical model comprises a rolling average of the historical errors.

28. The non-transitory computer readable medium of any one of clauses 21-27, wherein the offset is learned via a machine learning model.

29 The non-transitory computer readable medium of any one of clauses 21-28, wherein the object of interest is a plant.

30. The non-transitory computer readable medium of any one of clauses 21-29, wherein the implement comprises a light emitter.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 illustrates an isometric view of an autonomous laser weed eradication vehicle, according to example embodiments of the present disclosure.

FIG. 2 is a block diagram depicting components of a prediction system and a targeting system for manipulating an object, according to example embodiments of the present disclosure.

FIG. 3 is a block diagram illustrating a workflow 300 implemented by autonomous weed control system 200, according to example embodiments.

FIG. 4A is a flow diagram illustrating a method of targeting and manipulating an object, according to example embodiments of the present disclosure.

FIG. 4B is a flow diagram illustrating a method of targeting and manipulating an object, according to example embodiments of the present disclosure.

FIG. 4C is a flow diagram illustrating a method of targeting and manipulating an object, according to example embodiments of the present disclosure.

FIG. 4D is a flow diagram illustrating a method of determining a success rate, according to example embodiments of the present disclosure.

FIG. 5A is a block diagram illustrating a computing device, according to example embodiments of the present disclosure.

FIG. 5B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure is generally directed to systems and methods for reducing latency of targeting and manipulation of an object of interest.

Cultivation of crops is essential for food and textile production. One important component of crop management is the ability to control or eliminate undesirable plant species, such as weeds. Weeds may decrease crop yield by depriving a desired plant of resources including water, nutrients, sunlight, and space. Weeds may further interfere with crop growth by harboring pests or parasites that damage the desired plants.

Traditional weed control and eradication methods include hand cultivation or chemical herbicides. Hand cultivation is labor intensive, leading to increased cost of crop production and higher food and textile prices. Use of chemical herbicides may have negative environmental impacts including ground water contamination, acute toxicity, or long-term health effects such as cancer.

Development of eco-friendly and low-cost weed control and eradication methods is a driving factor for higher crop yield, lower food prices, and long-term environmental stability. Decreasing the need for manual labor may substantially lower farming costs and improve labor standards. Reducing or eliminating the need for herbicides may decrease many negative environmental side-effects of crop production, including toxic run-off and ground water contamination.

One or more techniques disclosed herein provide an eco-friendly and low-cost weed control system through the use of an autonomous weed eradication system. The autonomous weed eradication system may identify, target, and eliminate weeds, reducing overall latency and overhead of the weed control system.

As those skilled in the art understand, a vehicle carrying a weed control system may accumulate wear and tear over time, which can lead to wear and tear defects on the vehicle. Wear and tear could lead to sagging or deformation of components on the vehicle. Components, such as those relied on for predicting locations of objects of interest can lose accuracy or quality over time. Additionally, as the vehicle continues to scan the surface of fields for objects, the land of the field itself may change over time.

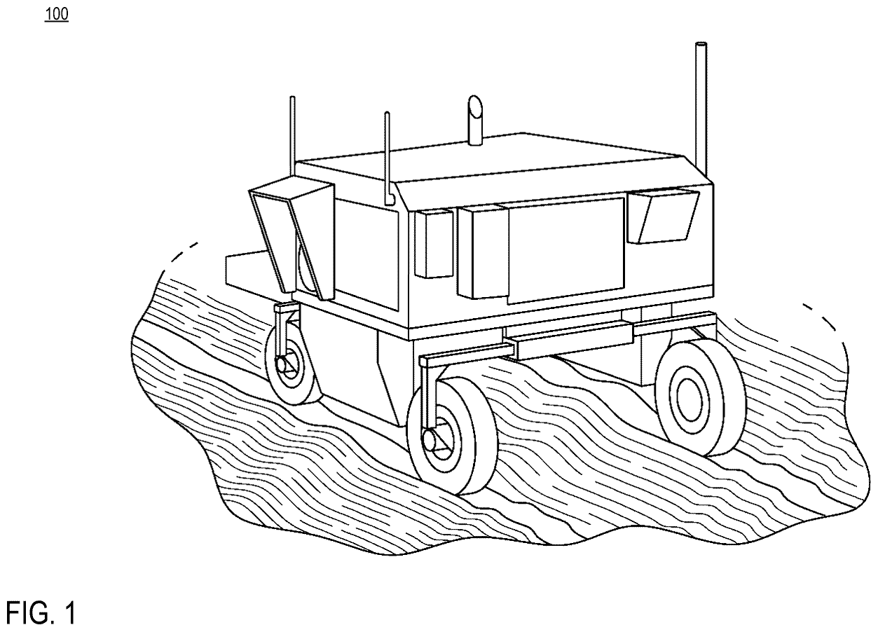

FIG. 1 illustrates an isometric view of an autonomous laser weed eradication vehicle 100, according to some embodiments. An autonomous laser weed eradication vehicle 100 may include an autonomous weed eradication system that can identify, target, and eliminate weeds without human input. Optionally, the autonomous weed eradication system may be positioned on a self-driving vehicle or a piloted vehicle or may be pulled by a vehicle such as a tractor.

An autonomous weed eradication system may be part of or coupled to a vehicle 100, such as a tractor or self-driving vehicle. The vehicle 100 may drive through a field of crops. As the vehicle 100 drives through the field, it may identify, target, and eradicate crops or weeds. The detection methods described herein may be implemented by the autonomous weed eradication system to identify, target, and eradicate weeds while the vehicle 100 is in motion. The high precision of such tracking methods enables accurate targeting of weeds or crops, such as with a laser, to eradicate the weeds or crops.

In some embodiments, the vehicle 100 may be a driverless vehicle. The driverless vehicle may be a robot. In some embodiments, the vehicle may be controlled by a human. For example, the vehicle may be driven by a human driver. In some embodiments, the vehicle may be coupled to a second vehicle being driven by a human driver, for example towed behind or pushed by the second vehicle. The vehicle may be controlled by a human remotely, for example by remote control. In some embodiments, the vehicle may be controlled remotely via longwave signals, optical signals, satellite, or any other remote communication method.

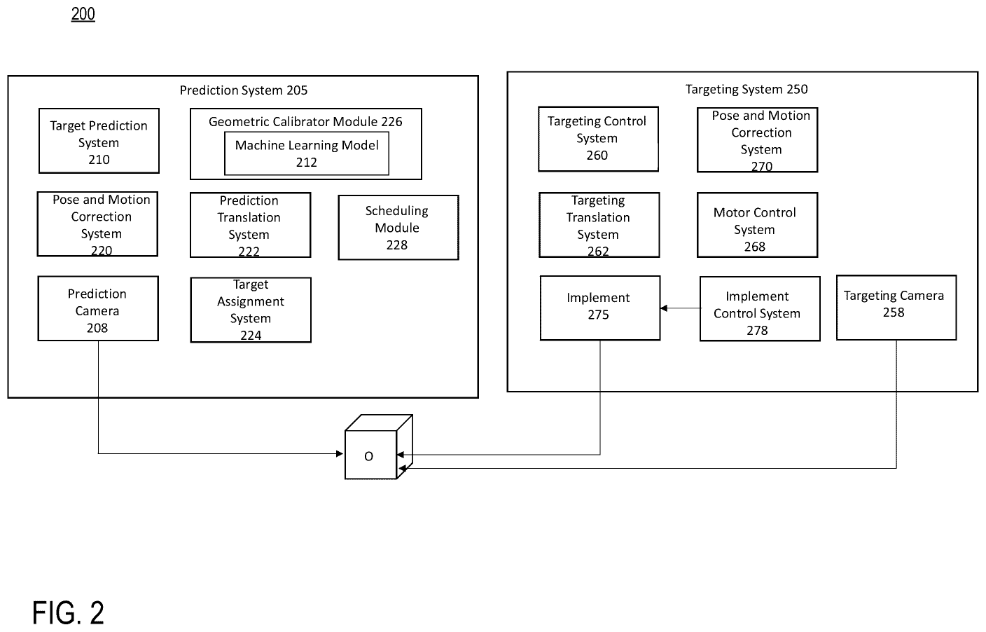

FIG. 2 illustrates an autonomous weed control system 200 including a prediction system 205 and a targeting system 250 for tracking and targeting an object, also referred to as a target, relative to a moving body, such as vehicle 100 illustrated in FIG. 1. The prediction system 205, the targeting system 250, or both may be positioned on or coupled to the moving body (e.g., the moving vehicle 100).

The prediction system 205 may include a prediction camera 208, a target prediction system 210, a pose and motion correction system 220, a geometric calibrator module 226, a prediction translation system 222, a target assignment system 224, and a scheduling module 228.

The prediction camera 208 may be configured to image a region, such as a region of a surface, containing one or more objects, including a target object. In some embodiments, a target prediction system 210 is configured to capture an image of a region of a surface using the prediction camera 208 or sensor to identify an object of interest in the image and determine a predicted location of the object. The predicted location of the object is referred to as a “low latency prediction” of the object.

The target prediction system 210 may include an object identification module configured to identify an object of interest and differentiate the object of interest from other objects in the prediction image. In some embodiments, the target prediction system 210 uses a machine learning model to identify and differentiate objects based on features extracted from a training dataset including labeled images of objects. For example, the target prediction system 210 may be trained to identify weeds or crops. In some embodiments, the machine learning model may be a deep learning model, such as a deep learning neural network. The machine learning model may be configured to identify a region in the image containing an object of interest. The region may be defined by a polygon, for example a rectangle. In some embodiments, the region is a bounding box or a polygon mask covering an identified region. In some embodiments, the machine learning model may be trained to determine a location of the object of interest, for example a pixel location within a prediction image. U.S. patent application Ser. No. 17/576,814, which is incorporated herein by reference, describes example machine learning models that may be used in accordance with the present technology for automated identification, maintenance, control, or targeting of targets.

A prediction translation system 222 may be configured to translate the location of the object in the prediction image into a location on the surface or a surface location relative to a detection system frame of reference. For example, the prediction translation system 222 may build multiple interpolation functions which may provide a translation from the location in the prediction image to one or more actuator positions, for example pan and tilt positions, of one or more actuators controlling one or more reflective elements, such as a mirror; for example, a dichroic mirror, or a dielectric mirror; a prism; a beam splitter, or any combination thereof.

The prediction system 205 may further include a pose and motion correction system 220. The pose and motion correction system 220 may include a positioning system. In some embodiments, the positioning system may be representative of one or more of a wheel encoder or rotary encoder, an Inertial Measurement Unit (IMU), a Global Positioning System (GPS), a ranging sensor (e.g., laser, SONAR, or RADAR), or an Internal Navigation System (INS). The pose and motion correction system 220 may utilize an IMU, which may be directly or indirectly coupled to the prediction camera 208. For example, the prediction camera 208 and the IMU may be mounted to a vehicle 100.

The IMU may collect motion readings of the IMU, and anything directly or indirectly coupled to the IMU, such as the prediction camera 208. For example, the IMU may collect readings that include three-dimensional acceleration and three-dimensional rotation information which may be used to determine a magnitude and a direction of motion over an elapsed time. The pose and motion correction system 220 may include a GPS. The GPS may be directly or indirectly coupled to a prediction camera 208 of a prediction system 205 or a targeting camera 258 of a targeting system 250. For example, the GPS may communicate with a satellite-based radio-navigation system to measure a first position of the prediction camera 208 at a first time and a second position of the prediction camera 208 at a second time.

The pose and motion correction system 220 may include a wheel encoder in communication with a wheel of the vehicle 100. The wheel encoder may estimate a velocity, or a distance traveled based on angular frequency, rotational frequency, rotation angle, or number of wheel rotations. In some embodiments, the positioning system and the detection system may be positioned on a vehicle. In some embodiments, the positioning system may be positioned on a vehicle that is spatially coupled to the detection system. For example, the positioning system may be located on a vehicle pulling the detection system.

The pose and motion correction system 220 may include an INS. The INS may be directly or indirectly coupled to the prediction camera 208. For example, the INS may include motion sensors, for example accelerometers, and rotation sensors, for example gyroscopes, to measure the position, the orientation, and the velocity of the prediction camera 208. The pose and motion correction system 220 may or may not use external references to determine a change in position of the prediction camera 208. The pose and motion correction system 220 may determine a change in position of the prediction camera 208 from a first position and a second position. In some embodiments, after the target prediction system 210 locates an object of interest in an image, the pose and motion correction system 220 may determine an amount of time that has elapsed since the image was captured and the magnitude and direction of motion of the prediction camera 208 that has occurred during the elapsed time. The pose and motion correction system 220 may integrate the object location, time elapsed, and magnitude and direction of motion to determine an adjusted location of the object on the surface.

The scheduling module 228 may select objects identified by target prediction system 210 and schedule which ones to target with the targeting system 250. The scheduling module 228 may schedule objects for targeting based on parameters such as object location, relative velocity, implement activation time, confidence score, weed type, or combinations thereof. For example, the scheduling module 228 may prioritize targeting objects predicted to move out of a field of view of a prediction camera 208 or a targeting camera 258 or out of range of an implement 275. In some embodiments, the scheduling module 228 may prioritize targeting objects identified or located with high confidence. In some embodiments, the scheduling module 228 may prioritize targeting objects with short activation times. In some embodiments, a scheduling module 228 may prioritize targeting objects based on a user's preferred parameters.

Activation time may be used to determine whether to target an object. In some embodiments, a scheduling module 228 may prioritize targeting objects with short activation times over objects with longer activation times. For example, a scheduling module 228 may schedule four objects with shorter activation times to be targeted ahead of one object with a longer activation time, such that more objects may be targeted and eliminated in the available time.

Based on the low latency prediction for the object, a target assignment system 224 may assign the object to a targeting system 250. In some embodiments, the targeting system 250 may be one of a plurality of targeting systems. The prediction system 205 may send the low latency prediction of the object of interest to the assigned targeting system 250. The low latency prediction of the object may be adjusted based on a magnitude and direction of motion during an elapsed time, or the location may be within a region defined by a polygon, or both.

The prediction system 205 may include a system controller, for example a system computer having storage, random access memory (RAM), a central processing unit (CPU), and a graphics processing unit (GPU). The system computer may include a tensor processing unit (TPU). The system computer should include sufficient RAM, storage space, CPU power, and GPU power to perform operations to detect and identify a target. The prediction camera 208 may provide images of sufficient resolution on which to perform operations to detect and identify an object. In some embodiments, the prediction camera 208 may be a charge-coupled device (CCD) camera or a complementary metal-oxide-semiconductor (CMOS) camera, a LIDAR detector, an infrared sensor, an ultraviolet sensor, an x-ray detector, or any other sensor capable of generating an image.

A targeting system 250 of the present disclosure may be configured to target an object identified by a prediction system 205. The targeting system 250 may include a targeting control system 260, a targeting translation system 262, an implement control system 278 for controlling an implement 275, a pose and motion correction system 270, a motor control system 268, and a targeting camera 258, described in conjunction below.

In some embodiments, the targeting system 250 may direct an implement 275 toward the object to manipulate the object. For example, the targeting system 250 may be configured to direct an implement 275, such as a laser beam, toward a weed or crop to burn the weed or crop. The implement 275 may be at least one of an infrared laser, an ultraviolet laser, and a visible laser. For example, in some embodiments the implement 275 includes an emitter that emits a beam having a wavelength of about 1 m, about 100 mm, about 10 mm, about 1 mm, about 100 μm, about 10 μm, about 1.5 μm, about 1 μm, about 900 nm, about 800 nm, about 700 nm, about 600 nm, about 500 nm, about 400 nm, about 300 nm, about 100 nm, about 10 nm, or about 1 nm. In some embodiments, the emitter emits a beam having a wavelength from about 1 m to about 100 mm, from about 100 mm to about 10 mm, from about 10 mm to about 1 mm, from about 1 mm to about 100 μm, from about 100 μm to about 10 μm, from about 10 μm to about 1.5 μm, from about 1.5 μm to about 1 μm, from about 1 μm to about 900 nm, from about 900 nm to about 800 nm, from about 800 nm to about 700 nm, from about 700 nm to about 600 nm, from about 600 nm to about 500 nm, from about 500 nm to about 400 nm, from about 400 nm to about 300 nm, from about 300 nm to about 100 nm, from about 100 nm to about 10 nm, or from about 10 nm to about 1 nm. In some embodiments, the emitter may be capable of emitting electromagnetic radiation up to 10 mW, up to 100 mW, up to 1 W, up to 10 W, up to 100 W, up to 1 kW, or up to 10 kW. In some embodiments, the emitter may be capable of emitting electromagnetic radiation from 10 mW to 100 mW, from 100 mW to 1 W, from 1 W to 10 W, from 10 W to 100 W, from 100 W to 1 kW, or from 1 kW to 10 kW.

In some embodiments, the implement 275 may additionally or alternatively include one or more other suitable instruments. In another example, the targeting system 250 may be configured to direct a grabbing tool to grab the object. In another example, the targeting system 250 may direct a spraying tool to spray fluid at the object. However, other implements are within the scope of the present disclosure, including but not limited to a planting implement, a harvesting implement, a pollinating implement, a marking implement, a blowing implement, or a depositing implement.

The targeting system 250 may receive the predicted location of the object from the prediction system 205 and may use the predicted location to precisely target the object with an implement 275 at a future time. The targeting control system 260 of the targeting system 250 may receive the predicted location of object from the prediction system 205 and may instruct the targeting camera 258, the implement 275, or both to point toward the predicted location of the object. The position of the targeting camera 258 and the position of the implement may be coupled. In some embodiments, a plurality of targeting systems 250 is in communication with the prediction system 205.

A targeting system 250 may include and communicate with an optical control system that includes at least one emitter that emits a beam along an optical path, a beam combining element, the targeting camera 258, reflective elements configured to deflect the beam controlled by actuators. One or more actuators may be configured to rotate the reflective elements, thereby changing the deflection of the beam path and translating a position at which the beam encounters a surface. In some embodiments, the actuators may rotate the reflective elements about an axis of rotation, providing translation of the position of the point at which the beam encounters the surface along a translational axis. In some embodiments, the reflective elements control the direction of the targeting camera 258. In some embodiments, the targeting system 250 may additionally or alternatively include one or more actuators that change the position of the emitter(s) themselves.

The targeting control system 260 may receive the predicted location of the object of interest from the prediction system 205 and may direct the targeting camera 258 toward the predicted location of the object. The targeting camera 258 may collect a targeting image of a region predicted to contain the object of interest. In some embodiments, the targeting system 250 includes an object matching module configured to determine whether the targeting image contains the object of interest identified by the prediction system 205, thereby coordinating a camera handoff using point to point targeting. The object matching module may account for differences in the appearance of the object in the prediction image and the targeting image due to differences between the prediction camera 208 and the targeting camera 258, such as camera type, resolution, magnification, field of view, or color balance and sensitivity, differences in imaging angle or position, movement of the detection system, variability of non-planar surfaces, differences in imaging frequency, or changes in the object between when the prediction image was collected and when the targeting image was collected. In some embodiments, the object matching module may account for distortions introduced by the optical system, such as lens distortions, distortions from ZnSe optics, spherical aberrations, or chromatic aberration.

In some embodiments, the object matching module may use an object matching machine learning (ML) module trained to identify the same object in different images, accounting for differences between the two images, for example, due to differences in the image sensors, such as sensor type, resolution, magnification, field of view, or color balance and sensitivity, differences in imaging angle or position, movement of the detection system, variability of non-planar surfaces, or changes in the object between when the two images were collected.

If the object matching module identifies the object of interest in the targeting image, the object matching module may determine the target location of the object. The object matching module may determine an offset between the predicted position of the object and the target location of the object. The targeting translation system 262 may adjust the direction of the targeting camera 258 by adjusting positions of the reflective elements. The positions of the reflective elements may be controlled by actuators, as described herein.

For example, the targeting translation system 262 may convert the pixel location of the target in a targeting image into pan or tilt values of one or both actuators corresponding to mirror positions predicted to deflect the beam to the target location. In some embodiments, the position of an implement 275, such as a laser, is adjusted to direct the implement toward the target location of the object. In some embodiments, movement of the targeting camera 258 and the implement 275 is coupled. If the object matching module does not identify the object of interest in the targeting image, the targeting translation system 262 may adjust the position of the targeting camera 258 and collect a second targeting image. In some embodiments, if the object matching module does not identify the object of interest in the targeting image, a different object may be selected from the prediction image, and a new predicted location may be determined. Reasons that the object matching module may fail to identify the object of interest in the target image may include inadequate motion correction or obstruction of the object in the targeting image.

The target location of the object may be further corrected using the pose and motion correction system 270. The pose and motion correction system 270 may use a positioning system, for example a wheel encoder, an IMU, a GPS, a ranging sensor, or an INS, to determine a magnitude and direction of motion of the targeting camera 258. In some embodiments, acceleration and rotation readings from an IMU coupled directly or indirectly to the targeting camera 258 is used to determine a magnitude and direction of motion. For example, the targeting camera 258 and the IMU may be mounted to a vehicle 100.

The IMU may collect motion readings of the IMU, and anything directly or indirectly coupled to the IMU, such as the targeting camera 258. For example, the IMU may collect readings including three-dimensional acceleration and three-dimensional rotation information which may be used to determine a magnitude and a direction of motion over an elapsed time. In some embodiments, the pose and motion correction system 270 may use a wheel encoder to determine a distance and velocity of motion of the targeting camera 258. In some embodiments, the pose and motion correction system 270 may use GPS to determine a magnitude and direction of motion of the targeting camera 258.

The wheel encoder may estimate a velocity, or a distance traveled based on angular frequency, rotational frequency, rotation angle, or number of wheel rotations. The velocity or distance traveled may be used to determine the position of a vehicle 100, such as a vehicle directly or indirectly coupled to the targeting camera 258, relative to a surface. In some embodiments, the pose and motion correction system 270 may be positioned on a vehicle 100. In some embodiments, the positioning system may be positioned on a vehicle 100 that is spatially coupled to the detection system. For example, the positioning system may be located on a vehicle pulling the detection system.

For example, the GPS may be mounted to the vehicle 100. The GPS may communicate with a satellite-based radio-navigation system to measure a first position of the targeting sensor, such as targeting camera 258 at a first time and a second position of the targeting camera 258 at a second time. In some embodiments, the pose and motion correction system 270 may use an INS to determine the magnitude and direction of motion of the targeting camera 258. For example, the INS may measure the position, the orientation, and the velocity of the targeting camera 258.

In some embodiments, after the targeting control system 260 locates an object of interest in an image, the pose and motion correction system 270 determines an amount of time that has elapsed since the image was captured and the magnitude and direction of motion of the targeting camera 258 that has occurred during the elapsed time. The pose and motion correction system 270 may integrate the object location, time elapsed, and magnitude and direction of motion to determine a corrected target location of the object. In some embodiments, the positioning system used by the pose and motion correction system 270 of the targeting system 250 and the positioning system used by the pose and motion correction system 220 of the prediction system 205 are the same. A future target location of the object may be determined based on a predicted magnitude and direction of motion during a future time period. In some embodiments, the positioning system used by the pose and motion correction system 270 of the targeting system 250 and the positioning system used by the pose and motion correction system 220 of the prediction system 205 are different.

The motor control system 268 may include software-driven electrical components capable of providing signals to the actuators, controlling the position, orientation, or direction of the targeting camera 258, the implement, 275 such as a laser, or both. In some embodiments, the actuators may control reflective elements. For example, the actuator control system may send a signal including actuator pan tilt values to the actuators. The actuators may adopt the signaled pan tilt positions and move the reflective elements around a rotational axis to positions such that a beam emitted by the implement 275 is deflected to the target location of the object, the corrected target location of the object, or the future target location of the object.

The targeting system 250 may include an implement control system 278. In some embodiments, the implement control system 278 may be a laser control system. The implement control system 278, such as the laser control system, may include software-driven electrical components capable of controlling activation and deactivation of the implement 275. Activation or deactivation may depend on the presence or absence of an object as detected by the targeting camera 258. Activation or deactivation may depend on the position of the implement 275 relative to the target object location. In some embodiments, the implement control system 278 may activate the implement 275, such as a laser emitter, when an object is identified and located by the target prediction system 210. In some embodiments, the implement control system 278 may activate the implement 275 when the range of the implement 275, such as the beam path, is positioned to overlap with the target object location. In some embodiments, the implement control system 278 may activate the implement 275 when the range of the implement 275 is within a region of the surface containing an object defined by a polygon, for example a bounding box or a polygon mask covering the identified region.

The implement control system 278 may deactivate the implement 275 once the object has been manipulated, such as grabbed, sprayed, burned, or irradiated; the region including the object has been targeted with the implement 275; the object is no longer identified by the target prediction system 210; a designated period of time has elapsed; or any combination thereof. For example, the implement control system 278 may deactivate the implement 275 once a region on the surface including a weed or crop has been scanned by the beam, once the weed or crop has been irradiated or burned, or once the beam or crop has been activated for a pre-determined period of time.

As those skilled in the art understand, while the additional step of generating a high accuracy prediction (e.g., generated by the targeting system 250) may improve the overall accuracy of autonomous weed control system 200, it also increases the overall latency of the system as the result of several extra steps being performed after the low latency prediction is generated (e.g., by the prediction system 205). Accordingly, in some embodiments, rather than waiting for the high accuracy prediction to be generated for purposes of targeting and/or manipulating objects of interest (e.g., at least for every object of interest), one or more techniques disclosed herein may primarily utilize the low latency prediction for targeting and manipulating objects of interest, thereby increasing efficiency of such object targeting and manipulation. In order to successfully rely on the low latency prediction for targeting and manipulating objects, the low latency prediction should also be reliable. The following discussion focuses on techniques for increasing reliability of the low latency prediction.

As shown, in some embodiments, prediction system 205 may further include a geometric calibrator module 226. The geometric calibrator module 226 may be configured to learn an offset to be applied to a low latency prediction (e.g., to calibrate the low latency prediction). Such an offset may, for example, be based on a rolling average (e.g., mean, median, etc.) of comparisons between low latency predictions for objects and their associated high accuracy predictions previously determined and/or applied. However, the offset may additionally or alternatively be determined based on other suitable calculations, as discussed further herein. Based on this comparison, geometric calibrator module 226 may learn offsets within a margin between the predicted location of the target and the calculated location of the target as the vehicle 100 continues to operate. Such learning process may be performed while vehicle 100 operates and generates, in real-time or near real-time, the data for training a machine learning model 212 of geometric calibrator module 226.

In some embodiments, to learn errors in the existing calibration, geometric calibration module 226 may use a calibration space. For example, the low latency prediction of the object of interest may be converted into a virtual three-dimensional representation (hereinafter “low latency virtual location”) and placed in the calibration space. In some embodiments, the high accuracy prediction generated by the targeting system 250 may also be converted into a virtual three-dimensional representation (“high accuracy virtual location”) and placed in the calibration space. In some embodiments, the calibration space may be divided into a grid. For example, the geometric calibrator module 226 may divide a calibration space into multiple dimensions along the different inputs (e.g., different cameras, different scanners, etc.). In some embodiments, the calibration space may be representative of a 4-dimensional space defined by an x-axis, a y-axis, a z-axis, and a time axis. Inputs may include the low latency virtual location, the high accuracy virtual location, the height of the object, the position and/or orientation of the prediction camera and/or targeting camera, and/or the like. In some embodiments, these inputs may be produced by a combination of camera images, wheel encoders, and/or deep learning models. The difference between the low latency virtual location and the high accuracy virtual location for an object may be referred to as an offset between prediction system 205 and targeting system 250 with respect to that object. In some embodiments, the offset may be specific to a particular prediction system 205 and targeting system 250 (e.g., individualized for a particular autonomous weed control system 200).

In some embodiments, the offset may be determined with respect to three or fewer geometrical dimensions. For example, in some embodiments, the offset may be calculated in three-dimensional space (x, y, z) (e.g., x-direction and y-direction oriented along a ground surface such as a field, with a z-direction oriented perpendicular to the ground surface as a height direction). As another example, in some embodiments, the offsets may be concentrated in two-dimensional space (e.g., x-direction and y-direction oriented along a ground surface such as a field). As another example, in some embodiments, the offsets may be concentrated in a single dimensional space (e.g., either the x- or y-direction oriented along a ground surface such as a field), such as depending on the direction of travel of the vehicle 100.

In some embodiments, n addition or as an alternative to the 3-dimensional, 2-dimensional, or 1-dimensional space, rotation around the x-direction, the y-direction, and/or the z-direction such as pan, tilt, and/or roll may be considered in the offset, thus forming a quaternion representation for the offset. In some embodiments, the quaternion may encode the rotational spatial offset around one or more axes in three-dimensional space. For example, quaternion may encode the pan, tilt, and/or roll values, such as encoding all six degrees of freedom including motion in the x-direction, the y-direction, the z-direction, pan, tilt, and roll.

In some embodiments, the calibration space may be used to account for distortions for where objects in a particular area of the virtual space may have a different equivalent offset for the same targeting system compared to objects in a different area of the virtual space. In some embodiments, the grid may be used to account for structural differences, such as a mirror being assembled slightly offset from where it was supposed to be. For example, assume a mirror relied upon by the targeting system 250 installed at an angle that was not to specification. This abnormality may result in objects in certain parts of an area appearing farther than they should or closer than they should.

Using the calibration space, machine learning model 212 of geometric calibrator module 226 may learn an offset between the prediction system 205 and the targeting system 250 based on the low latency virtual location and the high accuracy virtual location. For example, geometric calibrator module 226 may be a statistical model that learns an offset to be applied to a low latency prediction based on one or more offsets previously applied. Geometric calibrator module 226 may then apply this learned offset to the next predicted location for an object, thereby calibrating and increasing the accuracy of the low latency prediction for the object. Autonomous weed control system 200 may then determine a location of the next object of interest based on the low latency prediction generated by prediction system 205 and the learned offset applied by geometric calibrator module 226, without requiring a separate determination of a high accuracy virtual location (e.g., using the targeting system 250) for that object. The result of the combination of the low latency prediction generated by prediction system 205 and the learned offset applied thereto may be referred to as the “speculative predicted position.”

As previously described, the geometric calibrator module 226 may learn an offset to be applied to a low latency prediction based on a number of offsets previously applied (e.g., for a particular location in the calibration space or grid). In some embodiments, the previous offsets for a location in the calibration space may, for example, include the previous n offsets applied to or corresponding to that location in the calibration space (e.g., n=5, 10, 15, 25, 50, 100, 500, or more than 500). Additionally or alternatively, the previous offsets may include all offsets applied to or corresponding to that location in the calibration space over the previous n seconds (e.g., n=0.5, 1, 5, 10, 15, 30, 60, or more than 60).

The offset may be learned or otherwise determined in one or more suitable manners. For example, in some embodiments the offset may be based on a rolling average (e.g., mean, median, etc.) of a number of offsets previously applied. Other statistical models may additionally or alternatively be used to learn the offset. For example, a certain segment of the distribution of previous offsets for a location in the calibration space may be analyzed (e.g., mean, median, or mode of a central 25% or 50%, or other suitable percentage segment of the distribution of previously-applied offsets).

Additionally or alternatively, in some embodiments, machine learning model 212 may be representative of various machine learning algorithms that may be trained to learn an offset between the prediction system 205 and the targeting system 250 through a training process that includes a plurality of images captured by the prediction system 205 and the targeting system 250. Thus, rather than rely on a rolling average or other statistical model, machine learning model 212 may be trained to infer the offset based on a continuous or periodic training process.

In some embodiments, a vehicle may accumulate wear and tear over time, which can lead to wear and tear defects on the vehicle. Wear and tear could lead to sagging or deformation of components on the vehicle. Components, such as prediction camera 208 and targeting camera 258 can lose accuracy or quality over time. Additionally, as the vehicle 100 continues to scan the surface of fields for objects, the land of the field itself may change over time. All these variables may result in the machine learning model 212 applying a learned offset that may no longer achieve the threshold level of accuracy consistently.

In operation, autonomous weed control system 200 may permit targeting system 250 to target and/or manipulate an object of interest based on a determined success rate of the speculative position prediction. For example, in operation, prediction system 205 may generate a speculative position prediction for a target object and target prediction system 210 may generate a high accuracy prediction for the target object. Autonomous weed control system 200 may compare the speculative position prediction to the high accuracy prediction to generate a speculative error between the two predictions. If the success rate over time (or “success rate”) meets or exceeds a threshold, autonomous weed control system 200 may permit targeting system 250 to target and manipulate objects based on the speculative position prediction. For example, a speculative error may be deemed to be within an acceptable margin if it is less than 3.5 mm; if the success rate exceeds a threshold level of accuracy (e.g., for the last 100 objects, prediction system 205 yielded speculative errors within the acceptable margin 20% of the time), then autonomous weed control system 200 may permit targeting system 250 to target and/or manipulate an object based on the speculative position prediction. If, on the other hand, the success rate is less than the threshold, then autonomous weed control system 200 may target the object of interest based on the high accuracy prediction.

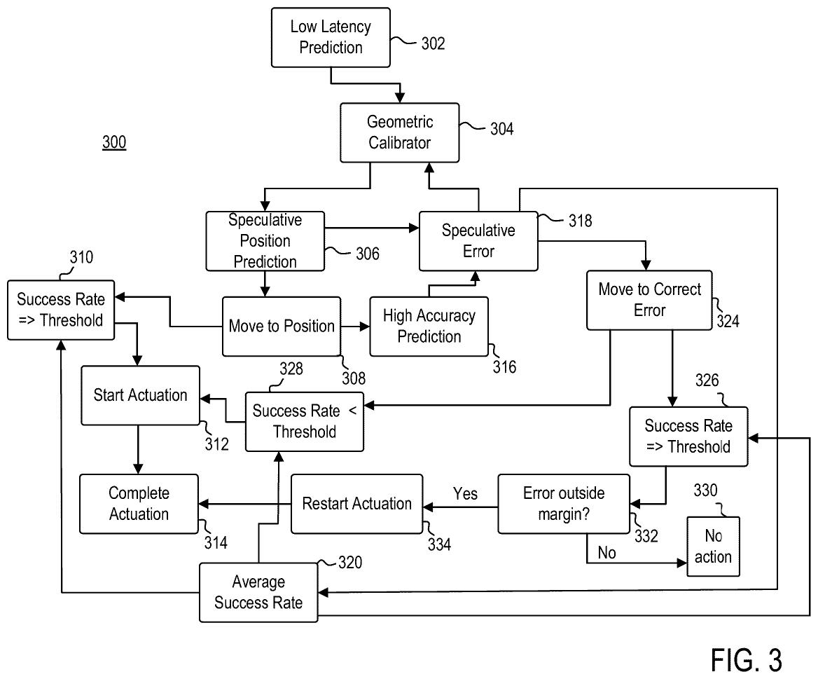

FIG. 3 is a block diagram illustrating a workflow 300 implemented by autonomous weed control system 200, according to example embodiments.

At block 302, prediction system 205 may generate a low latency prediction for a location of a target object. At block 304, the low latency prediction may be provided to the geometric calibrator module 226. At block 306, the geometric calibrator module 226 may generate a speculative position prediction by applying a learned offset to the low latency prediction. At block 308, based on the speculative position prediction, the implement 275 may be moved into position. Once the implement 275 is moved into position, at block 310 autonomous weed control system 200 may determine whether the success rate over time at least meets the threshold. For example, autonomous weed control system 200 may determine whether target prediction system 210 and, more specifically, geometric calibrator module 226, has maintained the threshold level of accuracy (e.g., 20%) over the last X attempts (e.g., the speculative position predictions generated by the target prediction system 210 was at least 20% accurate over the last 100 attempts).

If, at block 310, autonomous weed control system 200 determines that the success rate over time meets the threshold, then autonomous weed control system 200 may start actuation of the system 200 (or at least actuation of implement 275) (block 312) and complete actuation (block 314) based on the speculative position prediction from block 306. If, at block 310, autonomous weed control system 200 determines that the success rate over time is less than the threshold, then autonomous weed control system 200 may not start actuation based on the speculative position prediction.

Referring back to block 308, when the implement 275 is moved into position, target prediction system 210 may also generate a high accuracy position prediction at block 316. In some embodiments, target prediction system 210 may generate the high accuracy prediction in parallel to one or more of the foregoing steps. The high accuracy position prediction (i.e., the prediction generated by target prediction system 210) may be compared with the speculative position prediction (e.g., the calibrated prediction generated by prediction system 205) to determine a speculative error at block 318. The speculative error may determine whether the current speculative position prediction generated at block 306 is within an acceptable margin of the high accuracy position prediction (e.g., +/−3.5 mm). As such, autonomous weed control system 200 may continually check the accuracy of geometric calibrator module 226 when generating speculative position predictions to ensure that geometric calibrator module 226 is appropriately tuned. In some embodiments, this accuracy assessment may be performed and updated every time (or every n times, where n=1, 2, 3, 4, 5, or more, etc.) a speculative error is computed. Additionally or alternatively, in some embodiments, the accuracy assessment may be updated when the speculative error is outside of an acceptable margin of error (and in some embodiments, the accuracy assessment may be updated only when the speculative error is outside of an acceptable margin of error). Additionally or alternatively, an accuracy assessment of the prediction system may be performed and/or updated in other circumstances, such as periodically (e.g., every 30 seconds, every minute, every five minutes, every ten minutes, every thirty minutes, every hour, etc.), in response to detected environmental conditions (e.g., a change in lighting conditions, a change in wind conditions, etc.), and/or in response to a command (e.g., manually-entered command by an operator).

In some embodiments, the high accuracy position prediction may be used to target and manipulate an object of interest, such as when the success rate over time at block 310 is determined to be less than the threshold or when the speculative error is outside the acceptable margin.

After the speculative error is determined at block 318, workflow 300 may proceed to block 324. At block 324, autonomous weed control system 200 may move to correct the speculative error. From block 324, workflow 300 may proceed to block 328 or block 326, depending on the determined success rate.

At block 328, autonomous weed control system 200 may determine that the success rate was less than a threshold (i.e., autonomous weed control system 200 did not permit actuation to begin based on the speculative position prediction). In such embodiments, workflow 300 may proceed to block 312, and autonomous weed control system 200 may start actuation based on the high accuracy prediction generated at block 316. At block 314, autonomous weed control system 200 may complete actuation.

At block 326, autonomous weed control system 200 may determine that the success rate was equal to or greater than the threshold (i.e., autonomous weed control system 200 did permit actuation to begin based on the speculative position prediction). In such embodiments, workflow 300 may proceed to step 330 or step 332.

At step 330, autonomous weed control system 200 may determine that the speculative error is inside the acceptable margin. If the speculative error is inside the acceptable margin, then workflow 300 may proceed to step 330 and no further action may be needed because actuation was started based on the speculative position prediction and the error was deemed acceptable.

At step 332, autonomous weed control system 200 may determine that the speculative error was outside the acceptable margin. If the speculative error is outside the acceptable margin, then workflow 300 may proceed to block 334. At block 334, autonomous weed control system 200 may restart actuation. For example, at block 334, autonomous weed control system 200 may be aware of two facts: (1) actuation was started based on the speculative position prediction at block 306; and (2) the speculative position prediction upon which the actuation was started was outside the error margin. In other words, there is a chance that the autonomous weed control system 200 missed its target. In such situations, at block 334, autonomous weed control system 200 may be repositioned using the high accuracy prediction, and its actuation subsequently restarted, to ensure that the object of interest is accurately targeted and implemented. At block 314, autonomous weed control system 200 may complete actuation.

At block 320, geometric calibrator module 226 may re-generate the average success rate based on the speculative error determined at block 318 for the next object to be targeted. For example, assume that the object targeted by the foregoing process is object n and that the chosen window for the rolling average is based on the previous 10 targets, object n−10 through n−1. When the speculative error is determined for the speculative position prediction generated for object n, geometric calibrator module 226 may utilize its speculative error for determining the success rate for object n+1. Accordingly, the success rate for object n+1 is based on an average of speculative errors for objects n−9 through n and the speculative error for object n.

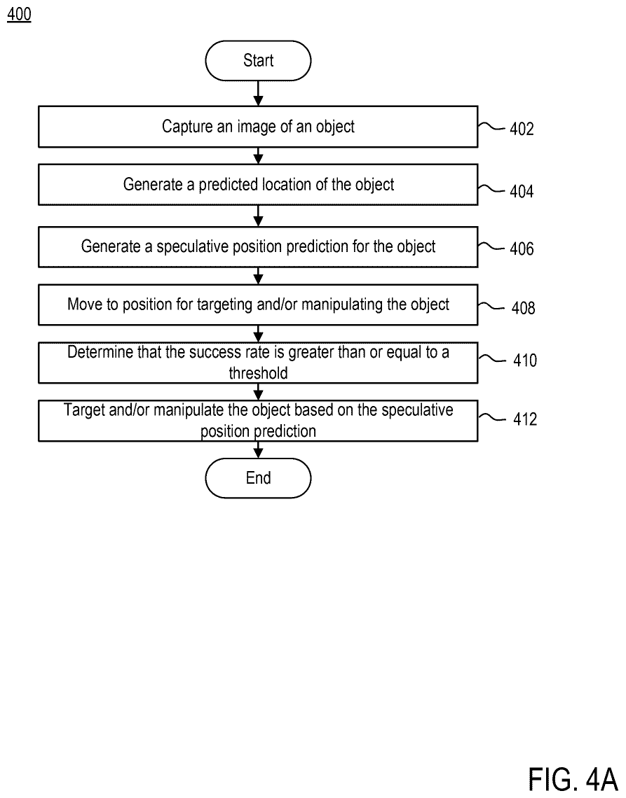

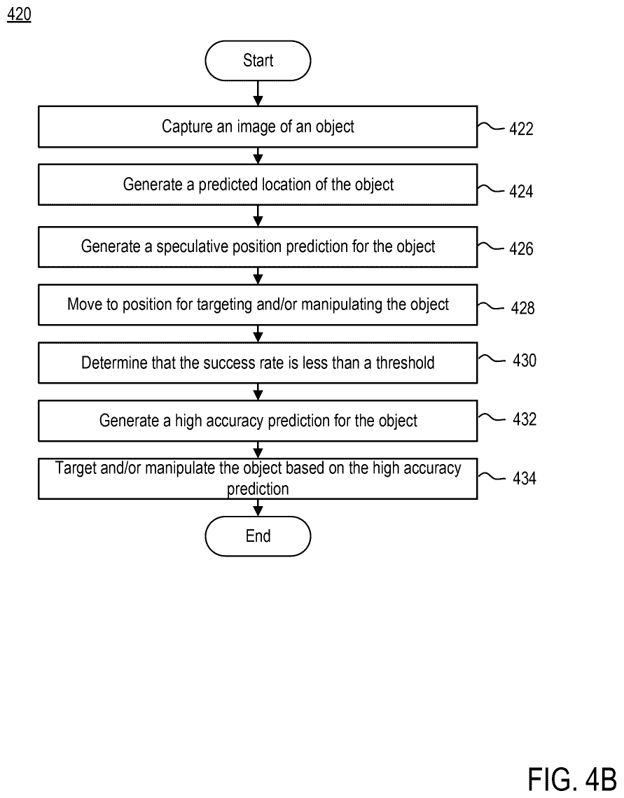

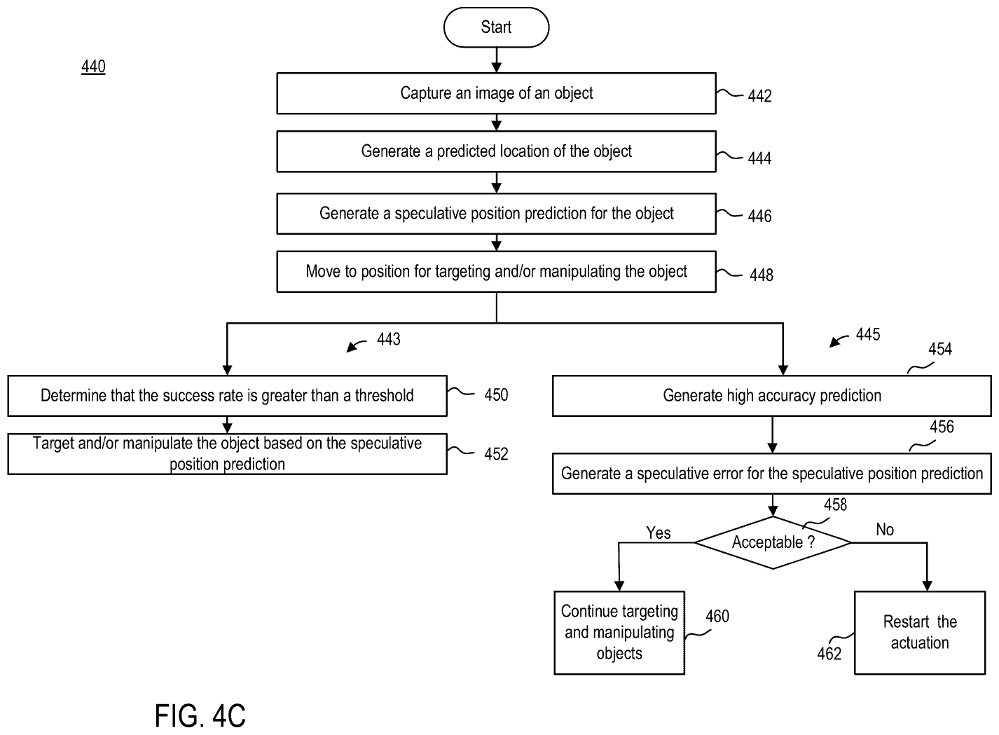

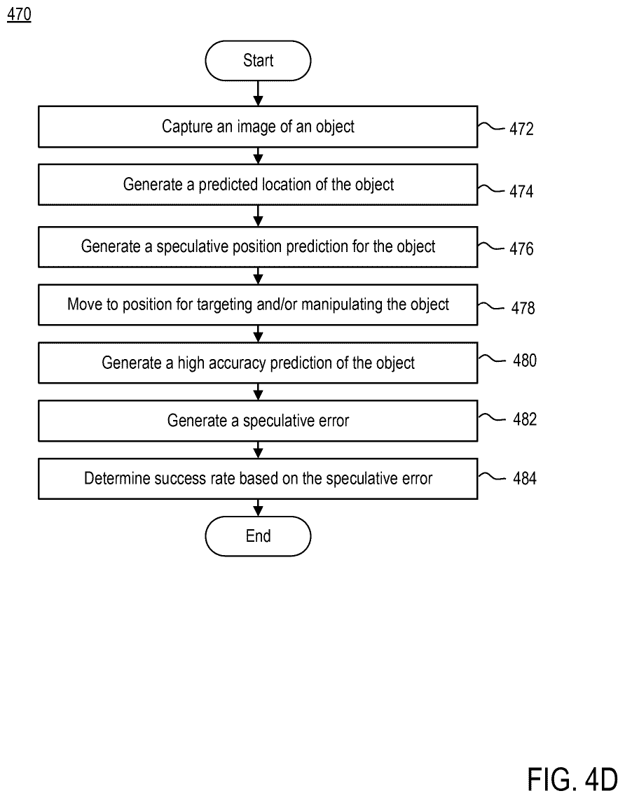

FIGS. 4A-4C are flow diagrams illustrating sub-workflows associated with workflow 300, according to example embodiments. While each of the sub-workflows are described independently, as shown above, they are a part of the same overarching workflow 300. Such discussion is shown for ease of understanding the various processes of autonomous weed control system 200.

FIG. 4A is a flow diagram illustrating a method 400 of targeting and manipulating an object, according to example embodiments of the present disclosure. Method 400 may begin at step 402.

At step 402, autonomous weed control system 200 may capture an image of an object. For example, the prediction camera 208 of the prediction system 205 may capture an image of an object as the vehicle 100 travels over a field.

At step 404, autonomous weed control system 200 may generate a predicted location of the object based off of the captured image. For example, using the image from the prediction camera 208, the target prediction system 210 of the prediction system 205 may generate a predicted location of the object in the image. Within the image, a pixel location may be converted to a location on the surface of the field. The location on the surface may be considered the predicted location. Such prediction may be referred to as a “low latency prediction.”

At step 406, autonomous weed control system 200 may generate a speculative position prediction for the object based on the low latency prediction. For example, geometric calibrator module 226 may apply a learned offset to the low latency prediction to generate the speculative position prediction.

At step 408, autonomous weed control system 200 may move to position to ready itself for targeting and manipulating the object.

At step 410, autonomous weed control system 200 may determine that the success rate is greater than a threshold. For example, autonomous weed control system 200 may determine that, over the last X targets, geometric calibrator module 226 achieved a threshold level of accuracy (e.g., over the last 100 targets, geometric calibrator module 226 was at least 20% accurate).

At step 412, autonomous weed control system 200 may target and manipulate the object based on the speculative position prediction.

FIG. 4B is a flow diagram illustrating a method 420 of targeting and manipulating an object, according to example embodiments of the present disclosure. Method 420 may begin at step 422.

At step 422, autonomous weed control system 200 may capture an image of an object. For example, the prediction camera 208 of the prediction system 205 may capture an image of an object as the vehicle 100 travels over a field.

At step 424, autonomous weed control system 200 may generate a predicted location of the object based off of the captured image. For example, using the image from the prediction camera 208, the target prediction system 210 of the prediction system 205 may generate a predicted location of the object in the image. Within the image, a pixel location may be converted to a location on the surface of the field. The location on the surface may be considered the predicted location. Such prediction may be referred to as a “low latency prediction.”

At step 426, autonomous weed control system 200 may generate a speculative position prediction for the object based on the low latency prediction. For example, geometric calibrator module 226 may apply a learned offset to the low latency prediction to generate the speculative position prediction.

At step 428, autonomous weed control system 200 may move to position to ready itself for targeting and manipulating the object.

At step 430, autonomous weed control system 200 may determine that the success rate is less than a threshold value. For example, autonomous weed control system 200 may determine that, over the last X targets, the accuracy of geometric calibrator module 226 was less than a threshold level of accuracy (e.g., over the last 100 targets, geometric calibrator module 226 was less than 20% accurate).

At step 432, autonomous weed control system 200 may generate a high accuracy prediction of the object. For example, targeting system 250 may generate a high accuracy prediction for the object based on the predicted location of the object as discussed above in conjunction with FIG. 2.

At step 434, autonomous weed control system 200 may target and manipulate the object based on the high accuracy prediction.

FIG. 4C is a flow diagram illustrating a method 440 of targeting and manipulating an object, according to example embodiments of the present disclosure. Method 440 may begin at step 402.

At step 442, autonomous weed control system 200 may capture an image of an object. For example, the prediction camera 208 of the prediction system 205 may capture an image of an object as the vehicle 100 travels over a field.

At step 444, autonomous weed control system 200 may generate a predicted location of the object based off of the captured image. For example, using the image from the prediction camera 208, the target prediction system 210 of the prediction system 205 may generate a predicted location of the object in the image. Within the image, a pixel location may be converted to a location on the surface of the field. The location on the surface may be considered the predicted location. Such prediction may be referred to as a “low latency prediction.”

At step 446, autonomous weed control system 200 may generate a speculative position prediction for the object based on the low latency prediction. For example, geometric calibrator module 226 may apply a learned offset to the low latency prediction to generate the speculative position prediction.

At step 448, autonomous weed control system 200 may move to position to ready itself for targeting and manipulating the object. From here, method 440 may follow two paths: path 443 and path 445. In some embodiments, path 443 may be performed simultaneously with or nearly simultaneously with path 445.

Path 445 may include step 450 and step 452.

At step 450, autonomous weed control system 200 may determine that the success rate is greater than a threshold value. For example, autonomous weed control system 200 may determine that, over the last X targets, geometric calibrator module 226 achieved a threshold level of accuracy (e.g., over the last 100 targets, geometric calibrator module 226 was at least 20% accurate).

At step 452, autonomous weed control system 200 may target and manipulate the object based on the speculative position prediction.

Path 445 may include steps 454-462.

At step 454, autonomous weed control system 200 may generate a high accuracy prediction of the object. For example, targeting system 250 may generate a high accuracy prediction for the object based on the predicted location of the object as discussed above in conjunction with FIG. 2.

At step 456. autonomous weed control system 200 may generate a speculative error for the speculative position prediction. For example, to generate the speculative error, autonomous weed control system 200 may compare the speculative position prediction to the high accuracy prediction.

At step 458, autonomous weed control system 200 may determine whether the speculative error is within an acceptable margin (e.g., within 3.5 mm). If, at step 458, autonomous weed control system 200 determines that the speculative error is within an acceptable margin, then method 440 may proceed to step 460 and autonomous weed control system 200 may continue targeting and manipulating objects. If, however, at step 458, autonomous weed control system 200 determines that the speculative error is not within an acceptable margin, then method 440 may proceed to step 462.

At step 462, autonomous weed control system 200 may restart the actuation to ensure that the object of interest was accurately targeted and manipulated based on the high accuracy prediction.

FIG. 4D is a flow diagram illustrating a method 470 of determining a success rate, according to example embodiments of the present disclosure. Method 470 may begin at step 462.

At step 472, autonomous weed control system 200 may capture an image of an object. For example, the prediction camera 208 of the prediction system 205 may capture an image of an object as the vehicle 100 travels over a field.

At step 474, autonomous weed control system 200 may generate a predicted location of the object based off of the captured image. For example, using the image from the prediction camera 208, the target prediction system 210 of the prediction system 205 may generate a predicted location of the object in the image. Within the image, a pixel location may be converted to a location on the surface of the field. The location on the surface may be considered the predicted location. Such prediction may be referred to as a “low latency prediction.”

At step 476, autonomous weed control system 200 may generate a speculative position prediction for the object based on the low latency prediction. For example, geometric calibrator module 226 may apply a learned offset to the low latency prediction to generate the speculative position prediction.

At step 478, autonomous weed control system 200 may move to position to ready itself for targeting and manipulating the object.

At step 480, autonomous weed control system 200 may generate a high accuracy prediction of the object. For example, targeting system 250 may generate a high accuracy prediction for the object based on the predicted location of the object as discussed above in conjunction with FIG. 2.

At step 482. autonomous weed control system 200 may generate a speculative error for the speculative position prediction. For example, to generate the speculative error, autonomous weed control system 200 may compare the speculative position prediction to the high accuracy prediction.

At step 484, autonomous weed control system 200 may determine the success rate taking into account the current speculative error. For example, as discussed above in conjunction with FIG. 4A, a success rate for the current object was relied upon for determining whether to target and manipulate the object based on the speculative position prediction alone. The success rate utilized for the current object (e.g., assume object n) may be based on the previous n−1 objects. Accordingly, the success rate determined in step 474 that takes into consideration the speculative error generated for object n may be used for determining whether the success rate for object n+1.

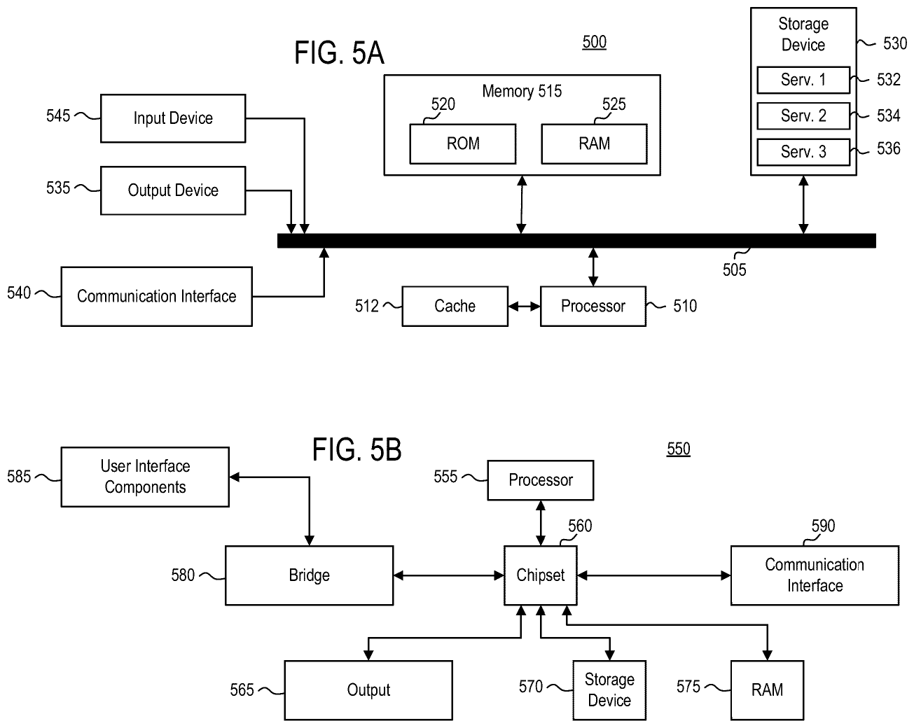

FIG. 5A illustrates a system bus architecture of computing system 500, according to example embodiments. System 500 may be representative of at least the autonomous weed control system 200. One or more components of system 500 may be in electrical communication with each other using a bus 505. System 500 may include a processing unit (CPU or processor) 510 and a system bus 505 that couples various system components including the system memory 515, such as read only memory (ROM) 520 and random-access memory (RAM) 525, to processor 510.

System 500 may include a cache of high-speed memory connected directly with, in close proximity to, or integrated as part of processor 510. System 500 may copy data from memory 515 and/or storage device 530 to cache 512 for quick access by processor 510. In this way, cache 512 may provide a performance boost that avoids processor 510 delays while waiting for data. These and other modules may control or be configured to control processor 510 to perform various actions. Other system memory 515 may be available for use as well. Memory 515 may include multiple different types of memory with different performance characteristics. Processor 510 may include any general-purpose processor and a hardware module or software module, such as service 1 532, service 2 534, and service 3 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system 500, an input device 545 may represent any number of input mechanisms, such as a microphone for speech, a touch-sensitive screen for gesture or graphical input, keyboard, mouse, motion input, speech and so forth. An output device 535 may also be one or more of a number of output mechanisms known to those of skill in the art. In some instances, multimodal systems may enable a user to provide multiple types of input to communicate with computing system 500. Communications interface 540 may generally govern and manage the user input and system output. There is no restriction on operating on any particular hardware arrangement and therefore the basic features here may easily be substituted for improved hardware or firmware arrangements as they are developed.

Storage device 530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 may include services 532, 534, and 536 for controlling the processor 510. Other hardware or software modules are contemplated. Storage device 530 may be connected to system bus 505. In one aspect, a hardware module that performs a particular function may include the software component stored in a computer-readable medium in connection with the necessary hardware components, such as processor 510, bus 505, output device 535 (e.g., display), and so forth, to carry out the function.

FIG. 5B illustrates a computer system 550 having a chipset architecture may be representative of at least the autonomous weed control system 200. Computer system 550 may be an example of computer hardware, software, and firmware that may be used to implement the disclosed technology. System 550 may include a processor 555, representative of any number of physically and/or logically distinct resources capable of executing software, firmware, and hardware configured to perform identified computations. Processor 555 may communicate with a chipset 560 that may control input to and output from processor 555.

In this example, chipset 560 outputs information to output 565, such as a display, and may read and write information to storage device 570, which may include magnetic media, and solid-state media, for example. Chipset 560 may also read data from and write data to storage device 575 (e.g., RAM). A bridge 580 for interfacing with a variety of user interface components 585 may be provided for interfacing with chipset 560. Such user interface components 585 may include a keyboard, a microphone, touch detection and processing circuitry, a pointing device, such as a mouse, and so on. In general, inputs to system 550 may come from any of a variety of sources, machine generated and/or human generated.

Chipset 560 may also interface with one or more communication interfaces 590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 555 analyzing data stored in storage device 570 or storage device 575. Further, the machine may receive inputs from a user through user interface components 585 and execute appropriate functions, such as browsing functions by interpreting these inputs using processor 555.

It may be appreciated that example systems 500 and 550 may have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

As used herein, an “image” may refer to a representation of a region or object. For example, an image may be a visual representation of a region or object formed by electromagnetic radiation (e.g., light, x-rays, microwaves, or radio waves) scattered off of the region or object. In another example, an image may be a point cloud model formed by a light detection and ranging (LIDAR) or a radio detection and ranging (RADAR) sensor. In another example, an image may be a sonogram produced by detecting sonic, infrasonic, or ultrasonic waves reflected off of the region or object. As used herein, “imaging” may be used to describe a process of collecting or producing a representation (e.g., an image) of a region or an object.

As used herein a position, such as a position of an object or a position of a sensor, may be expressed relative to a frame of reference. Exemplary frames of reference include a surface frame of reference, a vehicle frame of reference, a sensor frame of reference, or an actuator frame of reference. Positions may be readily converted between frames of reference, for example by using a conversion factor or a calibration model. While a position, a change in position, or an offset may be expressed in a one frame of reference, it should be understood that the position, change in position, or offset may be expressed in any frame of reference or may be readily converted between frames of reference.

As used herein, a “sensor” may refer to a device capable of detecting or measuring an event, a change in an environment, or a physical property. For example, a sensor may detect light, such as visible, ultraviolet, or infrared light, and generate an image. Examples of sensors include cameras (e.g., a charge-coupled device (CCD) camera or a complementary metal-oxide-semiconductor (CMOS) camera), a LIDAR detector, an infrared sensor, an ultraviolet sensor, or an x-ray detector.

As used herein, “object” may refer to an item or a distinguishable area that may be observed, tracked, manipulated, or targeted. For example, an object may be a plant, such as a crop or a weed. In another example, an object may be a piece of debris. In another example, an object may be a distinguishable region or point on a surface, such as a marking or surface irregularity.

As used herein, “targeting” or “aiming” may refer to pointing or directing a device or action toward a particular location or object. For example, targeting an object may include pointing a sensor (e.g., a camera) or implement (e.g., a laser) toward the object. Targeting or aiming may be dynamic, such that the device or action follows an object moving relative to the targeting system. For example, a device positioned on a moving vehicle may dynamically target or aim at an object located on the ground by following the object as the vehicle moves relative to the ground.

As used herein, a “weed” may refer to an unwanted plant, such as a plant of an unwanted type or a plant growing in an undesirable place or at an undesirable time. For example, a weed may be a wild or invasive plant. In another example, a weed may be a plant within a field of cultivated crops that is not the cultivated species. In another example, a weed may be a plant growing outside of or between cultivated rows of crops.

As used herein, “manipulating” an object may refer to performing an action on, interacting with, or altering the state of an object. For example, manipulating may include irradiating, illuminating, heating, burning, killing, moving, lifting, grabbing, spraying, or otherwise modifying an object.

As used herein, “electromagnetic radiation” may refer to radiation from across the electromagnetic spectrum. Electromagnetic radiation may include, but is not limited to, visible light, infrared light, ultraviolet light, radio waves, gamma rays, or microwaves.

### CONCLUSION

Although many of the embodiments are described above with respect to systems, devices, and methods for targeting and manipulating plants such as weeds or crops, the technology is applicable to other applications and/or other approaches, such as the targeting and manipulation of other objects of interest. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-5B.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of targeting an object of interest using a computing system comprising a prediction system and a targeting system, the method comprising:
receiving, from a camera, an image of the object of interest;
generating, by the prediction system, a predicted location of the object of interest based on the image;
generating an offset representing a difference between the prediction system and the targeting system;
applying the offset to the predicted location to generate a speculative position prediction of the object of interest causing an adjustment to an implement based on the speculative position prediction; and
targeting and manipulating the object of interest with the adjusted implement based on the speculative position prediction after the offset is applied.

2. The method of claim 1, further comprising:
generating, by the targeting system, a high accuracy prediction of the object of interest; and
comparing, by the targeting system, the high accuracy prediction to the speculative position prediction to assess an accuracy of the prediction system.

3. The method of claim 2, further comprising updating an accuracy assessment of the prediction system based on the high accuracy prediction and the speculative position prediction.

4. The method of claim 2, further comprising:
based on the comparing, determining, by the targeting system, that an error between the high accuracy prediction and the speculative position prediction is outside an acceptable margin of error; and
based on the determining:
causing a further adjustment to the implement based on the high accuracy prediction, and targeting and manipulating the object of interest after the implement is adjusted.

5. The method of claim 2, further comprising:
based on the comparing, determining, by the targeting system, that an error between the high accuracy prediction and the speculative position prediction is within an acceptable margin of error; and
based on the determining, continuing to manipulate the object of interest with the adjusted implement.

6. The method of claim 1, further comprising:
generating the offset between the prediction system and the targeting system based on a statistical model of historical errors between predicted positions generated by the prediction system and high accuracy predictions generated by the targeting system, wherein the statistical model is based on a window of the historical errors between the predicted positions and the high accuracy predictions.

7. The method of claim 6, wherein the statistical model comprises a rolling average of the historical errors.

8. The method of claim 1, wherein the offset is learned via a machine learning model.

9. The method of claim 1, wherein the object of interest is a plant.

10. The method of claim 1, wherein the implement comprises a light emitter.

11. A system comprising:
a prediction system; and
a targeting system, wherein the prediction system and the targeting system operate in conjunction to perform operations comprising:
receiving, from a camera, an image of an object of interest;
generating, by the prediction system, a predicted location of the object of interest based on the image;
generating an offset representing a difference between the prediction system and the targeting system;
applying the offset to the predicted location to generate a speculative position prediction of the object of interest;
causing an adjustment to an implement based on the speculative position prediction; and
targeting and manipulating the object of interest with the adjusted implement based on the speculative position prediction after the offset is applied.

12. The system of claim 11, wherein the operations further comprise:
generating, by the targeting system, a high accuracy prediction of the object of interest; and
comparing, by the targeting system, the high accuracy prediction to the speculative position prediction to assess an accuracy of the prediction system.

13. The system of claim 12, wherein the operations further comprise updating an accuracy assessment of the prediction system based on the high accuracy prediction and the speculative position prediction.

14. The system of claim 12, wherein the operations further comprise:
based on the comparing, determining, by the targeting system, that an error between the high accuracy prediction and the speculative position prediction is outside an acceptable margin of error; and
based on the determining:
causing a further adjustment to the implement based on the high accuracy prediction, and
targeting and manipulating the object of interest after the implement is adjusted.

15. The system of claim 12, wherein the operations further comprise:
based on the comparing, determining, by the targeting system, that an error between the high accuracy prediction and the speculative position prediction is within an acceptable margin of error; and
based on the determining, continuing to manipulate the object of interest with the adjusted implement.

16. The system of claim 1, wherein the operations further comprise:
generating the offset between the prediction system and the targeting system based on a statistical model of historical errors between predicted positions generated by the prediction system and high accuracy predictions generated by the targeting system, wherein the statistical model is based on a window of historical errors between the predicted positions and the high accuracy predictions.

17. The system of claim 6, wherein the statistical model comprises a rolling average of the historical errors.

18. The system of claim 1, wherein the offset is learned via a machine learning model.

19. The system of claim 1, wherein the object of interest is a plant.

20. The system of claim 1, wherein the implement comprises a light emitter.

21. A non-transitory computer readable medium having instructions stored thereon that, when executed by a processor, causes a computing system to perform operations comprising:
receiving, from a camera, an image of an object of interest;
generating, by the prediction system, a predicted location of the object of interest based on the image;
generating an offset representing a difference between the prediction system and the targeting system;
applying the offset to the predicted location to generate a speculative position prediction of the object of interest;
causing an adjustment to an implement based on the speculative position prediction; and
targeting and manipulating the object of interest with the adjusted implement based on the speculative position prediction after the offset is applied.
